(19) United States
(12) Patent Application Publication
(10) Pub. No.: US 2008/0005324 A1
(43) Pub. Date: Jan. 3, 2008

(54) ACCESSING OF PORTIONS OF AN INITIAL DIGITAL FILE PRELIMINARY TO THE ACCESS OF ANOTHER DIGITAL FILE

(76) Inventors: Li Ge, Austin, TX (US); Hui Jiang, Austin, TX (US); Yu Tang, Round Rock, TX (US); Ping Wang, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/427,098

(22) Filed: Jun. 28, 2006

(51) Int. Cl. G06F 15/173

(52) U.S. Cl. 709/225

(57) ABSTRACT

Predetermining a first set of data entry protocols for enabling a user to access one or more portions of an initial digital file. Predetermining a second set of data entry protocols for enabling a user to access another digital file by entering this second set of data entry protocols in response to the user accessing a threshold of a predetermined number of such portions. The first set of data entry protocols may include an acceptance by the user to pay a first fee for each accessed portion. In addition, under such circumstances, the access to the another digital file may be offered free of any fee as a reward for the user paying fees for the portions of the initial digital file accessed reaching a predetermined threshold level.

### CROSS-REFERENCE TO RELATED PATENT APPLICATION

The following copending patent application, which is assigned to the same assignee as the present invention, covers subject matter related to the subject matter of the present patent application: application (Attorney Docket No. AUS920060353US1) filed on the same date as the present application, entitled: Accessing of Sample Portions of a Large Digital File Preliminary to the Access of the Entire File, Li Ge et al., hereby incorporated by reference.

### TECHNICAL FIELD

The present invention relates to accessing of digital files from databases and particularly to databases at World Wide Web sites maintained on the Web, and more particularly to implementations enabling interactive users to effectively preview portions of such digital files.

### BACKGROUND OF RELATED ART

The past generation has been marked by a technological revolution driven by the convergence of the data processing industry with the consumer electronics industry. The effect has, in turn, driven technologies that have been known and available but relatively quiescent over the years. A major one of these technologies is the Internet or Web. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of databases providing documents, media and computer programs through related distribution of Web documents, e.g. Web pages or electronic mail. Because of the ease with which documents are distributable via the Web, it has become a major source of data in all forms, e.g. documents, audio-visual presentations including movies, audio text and music, videos and computer programs.

Virtually all databases of such public information and data throughout the world are accessible and able to be searched via the Web. The ease with which great volumes of data may be searched from a computer attached to the Internet and equipped with a Web browser has led to the development of widespread electronic commerce over the Web. At the present time, it is becoming very rare to find a business organization of any kind that does not transact some aspect of the business via the Web.

The accessing of textual data from the Web is in the form of Web documents, e.g. Web pages available from Web sites that maintain databases of information from which such Web documents are formed. This is conventionally done via a Web browser installed at the receiving computer terminal or station that accesses the Web sites. The audio-visual content and computer programs are also accessible from databases maintained at such Web sites.

In the electronic commerce Web technology, the success of the global networks, such as the Web or Internet (used interchangeably herein), is very evident in the continually increasing volumes of transactions including consumer sales. However, in the areas of data distribution, including audio and video presentations, the opportunities for business profits have not kept pace with those in electronic commerce.

Through these global networks, the user has access to vast repositories of data. In order for these database repositories and access to these databases to be continued to be maintained, more incentives need to be found for the providers and hosts of such databases. The demand for user access, as well as the amount of data that must be maintained in a database has increased to such a great extent that goodwill and even advertising revenue are becoming insufficient compensation for the database maintainers and providers. Thus, the industry is facing the fact that increasingly the user accessing the data will have to be charged an equitable fee for the data.

### SUMMARY OF THE PRESENT INVENTION

The above-referenced copending application provides an equitable implementation for providing compensation for the providers of files from maintained databases by charging the requesting user a fee for such files. However, since, the user usually cannot pay for a file without previewing it the invention provides for a modest or nominal previewing fee that can be absorbed into the eventual purchase fee for the digital data file being previewed.

It is noted that the audio music field, e.g. MP3 files, has already painfully recognized that audio music cannot be provided for free and that field now has many database providers who permit access to MP3 music at a fee. In addition, in this field a large market of music listeners has been developed who are willing to pay fair and reasonable fees for the MP3 music downloaded from Web site databases. In the illustrative embodiment that subsequently follows, we will use the MP3 music field as the embodiment in which to illustrate the present invention that provides reasonable previews of portions of music files that are available for purchase.

While the copending application provides the user with options in the accessing of the entire file from which the portions are being sampled, the present invention goes beyond the options offered by the Copending Application by providing an implementation for accessing digital files from a database wherein the users, accessing portions of an initial or original file for which the users may have an interest, are offered and are enabled to access other digital files also of potential interest to the user.

Accordingly, the present invention, like the copending application, includes the steps of determining a first set of data entry protocols for enabling a user to access, such as to preview, one or more portions of an initial digital file. However, in our embodiment of the present invention, the predetermined second set of data entry protocols enables a user to access another digital file by entering this second set of data entry protocols in response to said user accessing a threshold of a predetermined number of such portions.

The first set of data entry protocols may include an acceptance by said user to pay a first fee for each accessed portion. In addition, under such circumstances, the access to the another digital file may be offered free of any fee as a reward for the user paying fees for the portions of the initial digital file accessed reaching a predetermined threshold level.

In accordance with a further aspect of the invention, a third set of data entry protocols may be provided for enabling a user to pay a second fee for the entire initial digital file in lieu of the total of said first fees for all accessed portions wherein said second fee is greater than the total of said first fees; and the user may then be enabled to selectively substitute the accessed another digital file for said initial digital file. This expedient will permit a user, who has accessed a number of portions of, for example, an audio music file and decided that he has no interest in the entire initial file, to continue to pursue his possible interest in another alternate music file under the same terms and conditions.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network (Web) portion, i.e. an MP3 player connected to a desktop computer, connected to the Web via a server, to illustrate how the present invention accesses preview portions of the MP3 files before having an opportunity to acquire the whole MP3 digital file or to have access to other MP3 digital files in accordance with the present invention;

FIG. 2 is an exemplary block diagram of a data processing system including a central processing unit and network connections via a communications adapter that functions as the desktop computer display station through which preview portions, as well as entire digital files, may be accessed from provider sources via the Web;

FIG. 3 is an illustrative desktop computer display screen showing an exemplary interactive interface of the present invention that permits the interactive user to access preview portions of, and eventually entire initial or alternative digital files;

FIG. 4 is an exemplary illustrative display screen of FIG. 3 after the interactive user has satisfied the protocols for accessing another digital file, and is prompted with a menu of such other digital files for selection;

FIG. 5 is another example of an illustrative display screen of FIG. 3 after the user has satisfied the protocols for accessing another digital file, and is prompted with a menu of such other digital files for selection;

FIG. 6 is an illustrative flowchart describing the setting up of the programming functions to form the implementation of enabling a user to selectively access preview portions and then other digital files in accordance with an embodiment of the present invention; and

FIG. 7 is a flowchart of an illustrative run of the program set up according to FIG. 6.

### DETAILED DESCRIPTION OF THE PREFERRED EMBODIMENT

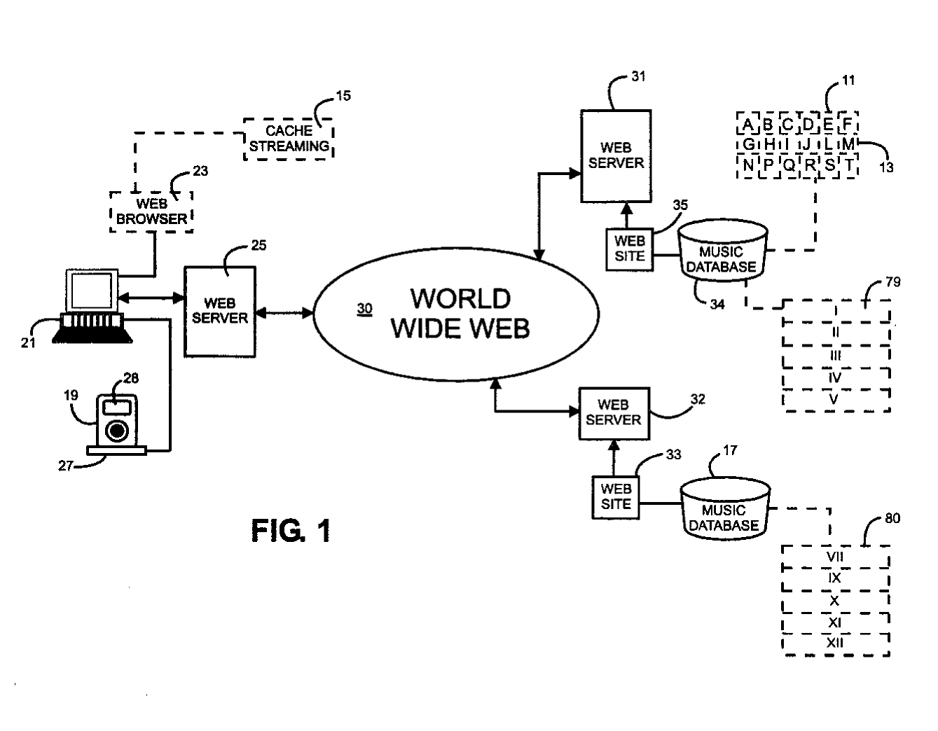

Referring to FIG. 1, a generalized example of the practice of the present invention involves a generalized portion of the Web that serves as the illustrative communication network in this embodiment of the present invention. An MP3 player 19 connected to and supported by desktop computer 21 is provided on which the user will preview portions of the entire digital file of audio music in deciding whether to download and store the entire music file. MP3 player 19, with display 28, e.g. an iPod™, is connected to dock 27 that, in turn, is connected to and synchronized with desktop computer 21 that, in turn, is connected to the Web 30 through its Web server 25 so that a user of computer controlled display terminal 21 may navigate on the Web 30 under the control of the Web browser program 23 in the desktop 21. The docking connection is a high-speed FireWire or USB 2.0 connection. The docking and connection to the desktop is described in greater detail at pp. 162-163 of the 2006 text, iPodi™+iTunes™ for Windows™ and Mac™ in a Snap, Brian Tiemann, Sams Publishing, Indianapolis, Ind. The synchronization and loading between the computer 21 and the MP3 player 19 is described in Chapter 6, pp. 161-198 of the text. When the accessing of the music file portions and the accessing of the entire music file are hereinafter described, it will be understood that desktop computer 21 under control of a conventional Web browser 23 obtains the portions of the entire music file from music file provider databases 34 or 17, at provider Web sites 35 and 33, respectively accessed through their Web servers 31 and 32. As will be hereinafter described in greater detail, during the listening to of portions of the entire digital file, the portions will be streamed via the Web and temporarily stored in small packets in cache 15 associated with the browser while the portion is being played. To illustrate, an entire music file 11 having accessible portions 13 is shown stored on database 34. Up to this point the structure described is substantially the structure described in the above-referenced copending application.

In addition, an embodiment of the present invention provides a set 79 of other digital audio music files: I through V at database 34, and a set 80 of other digital audio music files at database 17. As will be hereinafter described in greater detail, these sets will provide the other digital music files in accordance with present invention.

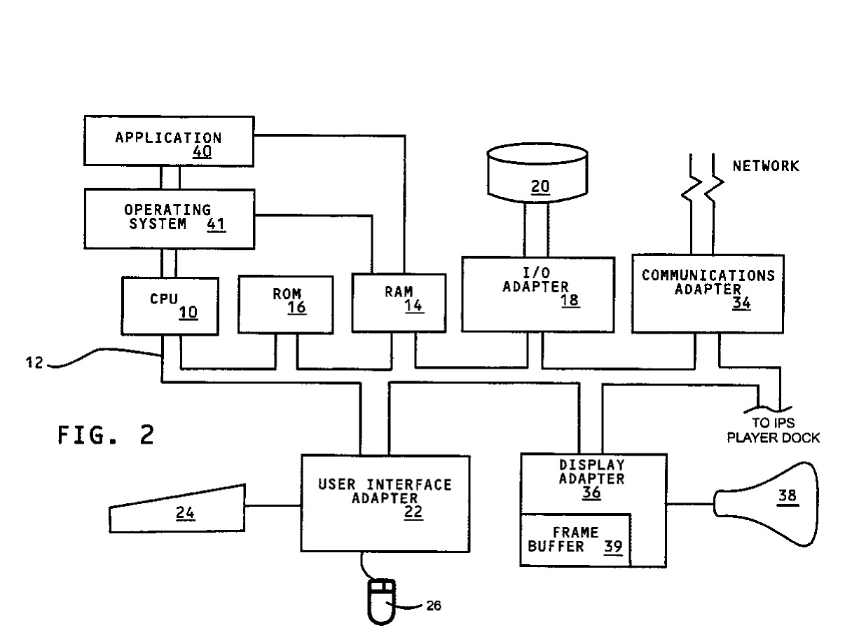

A typical computer that may be used in the practice of the invention for the desktop computer terminal or any of the servers shown in FIG. 1 will be described with respect to FIG. 2. A central processing unit (CPU) 10, such as one of the PC microprocessors or workstations available from International Business Machines Corporation (IBM) or Dell™ PC microprocessors, is provided and interconnected to various other components by system bus 12. An operating system 41 runs on CPU 10, provides control and is used to coordinate the function of the various components of the computer of FIG. 2. Operating system 41 may be one of the commercially available operating systems, such as IBM's AIX or Microsoft's WindowsXP™ or Windows 2000™, as well as UNIX™ and other IBM AIX operating systems. Application programs 40, controlled by the system, are moved into and out of the main memory Random Access Memory (RAM) 14. These programs include programs of the present invention and the Web browser for accessing portions of the entire file, as well as the subsequent accessing of other digital files. These functions, which will be described hereinafter, will access the Web controlled by conventional Web browsers, e.g. browsers 23, FIG. 1 at Web display terminals 21 (FIG. 1), such as Microsoft's Internet Explorer™.

A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage drive 20. Communications adapter 44 interconnects bus 12 with an outside network, e.g. the Web. Bus 12 is also connected to the MP3 player dock (27, FIG. 1). I/O devices are also connected to system bus 12 via user interface adapter 22 and display adapter 36. Keyboard 24 and mouse 26 are all interconnected to bus 12 through user interface adapter 22. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

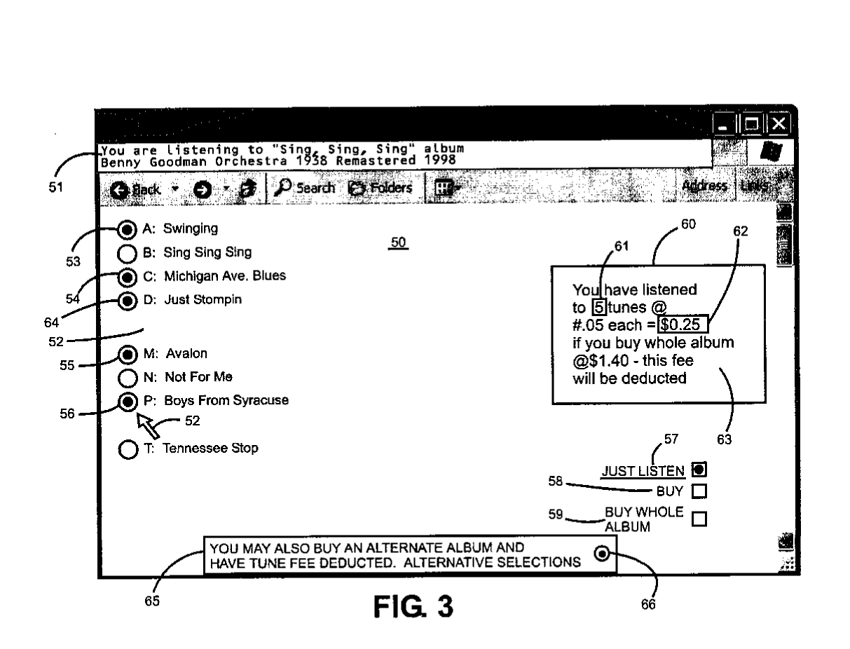

In FIG. 3, there is illustrated a simplified composite display screen 50 that may be used at the interactive user interface on the desktop terminal 21 of FIG. 1. The user is interested in perhaps buying the entire digital file, i.e. album, but wishes to sample or preview portions. The user has selected the Just Listen 57 button, and has already listened to selections, i.e. portions 53, 54, 55, 56 and 64, of the full digital (album) file (from portions 11 of file 13, FIG. 1). These portions have been selected through cursor 52. The user could have bought any of these portions individually by selecting the buy button 58. This would have resulted in the conventional downloading and storage of the individually bought file. In any event, in accordance with an embodiment of the present invention, the user has just chosen to listen to the five tunes thus far and has not as yet decided on the purchase of the entire file (album). Accordingly, in dialog window 60 that keeps track of the portions listened to, the user is advised that he has listened to 5 portions, 61, at a user agreed price of $0.05 each for a total of $0.25, 62. The user is also prompted, 63, that should he decide to buy the entire music file (album), that the listening charge would be deducted from the $1.40 charge for the entire album file. When the user selects to buy, the whole file would be accessed from the music database 34 Web site in FIG. 1 and downloaded to the user's computer terminal 21, FIG. 1. It should be noted that the provider or host of the database is enabled to set a threshold of a predetermined number of portions that must be listened to before the user will have the opportunity to buy the whole file 59. In the present example, since the offer to buy is prompted in dialog box 60, we may assume that the threshold was five listened to portions.

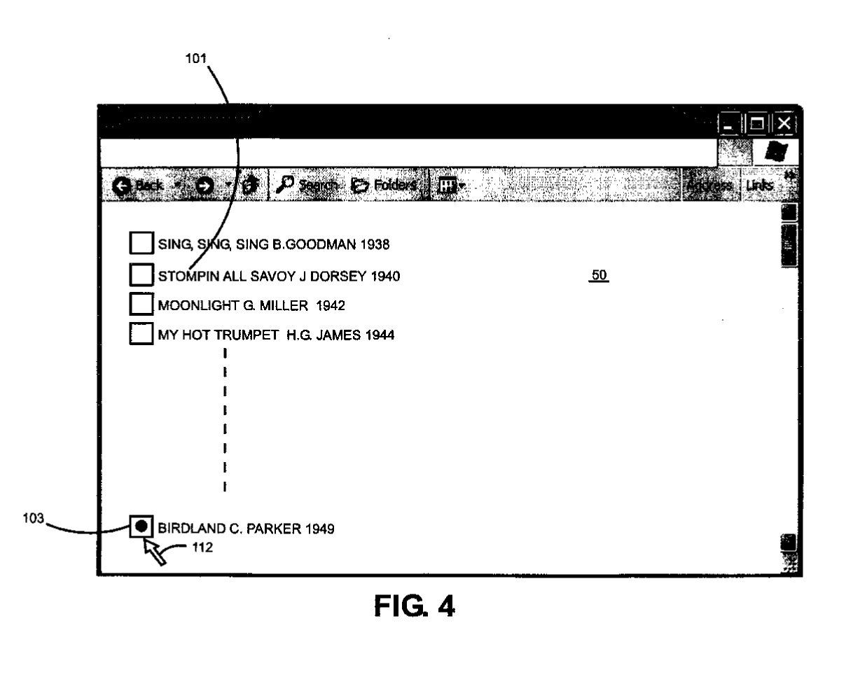

Up to this point, the display screen shown in FIG. 3 follows the same process of the referenced copending application. However, the present example now offers an alternative embodiment. It is based on the recognition that a user, after listening to the several portions, may have lost interest in the particular album or file selected. At this point, in an implementation of the copending application, the user customer may pay the nominal fee for listening and exit the session. Here, via dialog box 65, the user is prompted with the ability to listen to other alternative albums, digital music files wherein his already accumulated listening fees will be deducted should the listener decide to buy another file under the same protocols provided for the initial or original files. This provides an opportunity to retain an interested user/customer. In the present example, the user has selected to continue and pressed button 66 that brings up the display screen 50 of FIG. 4.

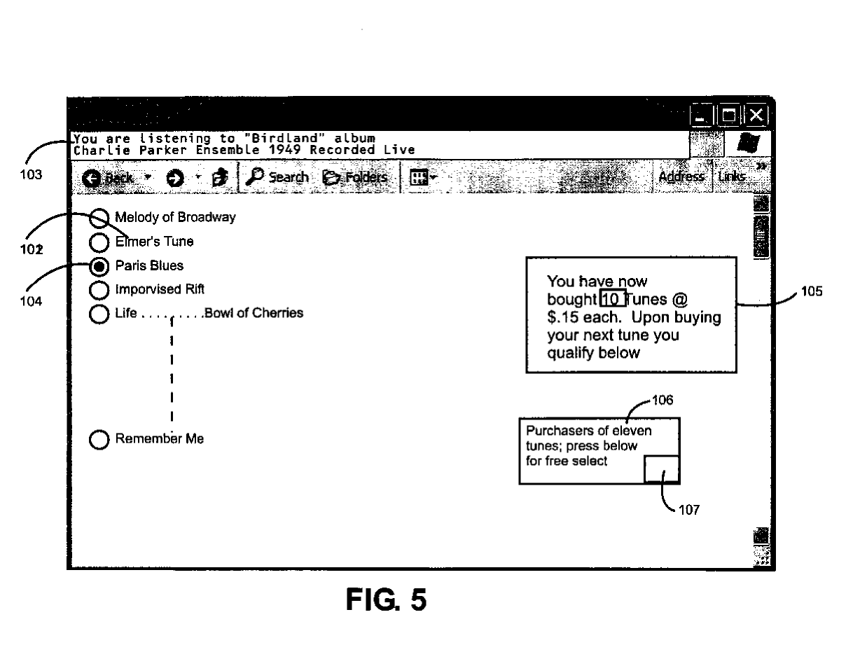

Since the original or initial digital file, i.e. album, was of the classical jazz genre, the selections offered from menu 101 are of that genre. Here the user has selected item 103 from the menu via cursor 112. The user is now presented with the display screen shown in FIG. 5 from which he may listen to portions of the other exemplary digital music file: “Birdland” album that the user may continue to treat according to the procedure described with respect to FIG. 3 wherein the user is credited for his charges for the portions selected from both the initial and the another digital music files should the user decide to purchase the whole another exemplary digital music file: “Birdland”.

There is also another embodiment of the invention illustrated in FIG. 5. Let us assume that in the illustration the user is buying the individual portions or tunes for downloading to his desktop computer. He has just made his selection of his next tune 104 from menu 102 listing the tunes in album 103. The user is alerted after his 10th purchase of a tune, via dialog box 105, that upon his next or 11th purchase of a portion or tune, he may press button 107 in dialog box 106 to receive another album or digital file without additional fee.

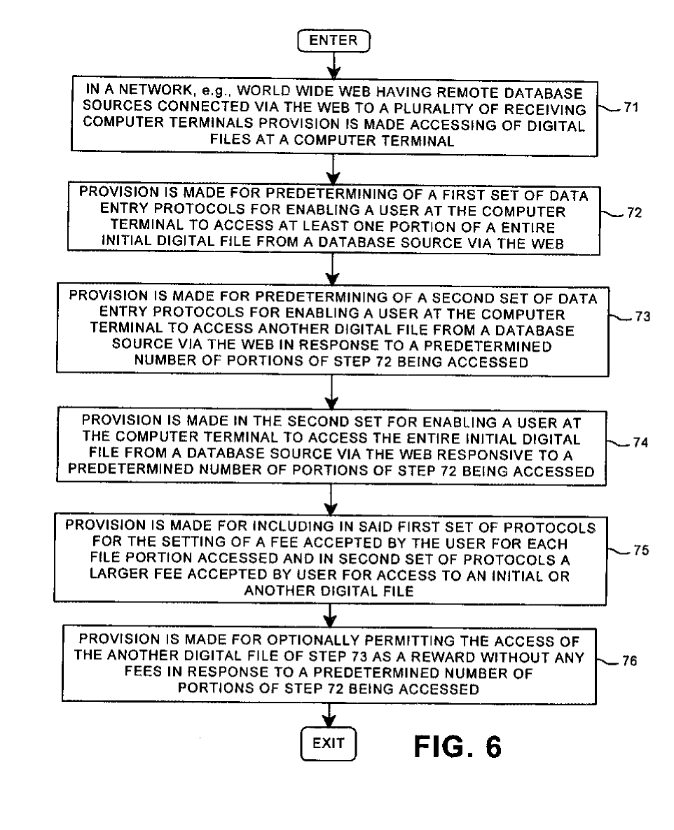

Now, with reference to the programming shown in FIG. 6, there will be described how the system and programs of the present invention are set up. For purposes of the present illustrative embodiment, we will present an implementation in which the entire initial digital file, as well as the other files that may be accessed, are audio music files such as albums, and the portions are tunes or individual songs in the album. It will be understood that the principles of the invention as illustrated will be applicable to other digital files accessed from remote sites on a network, such as text files, files comprising computer programs, films, games or video presentations.

The digital files involved are accessible via the Web from remote databases to receiving user computer terminals, step 71. Provision is made for predetermining a first set of protocols that the user at the receiving terminal must accept by appropriate data entry in order to access one or more portions of the entire digital file from the database via the Web, step 72. These protocols may involve the acceptance of charges or fees, the acceptance of specified security requirements, authentication of identifiers for the terminal or the user, or acceptance of specified use restrictions. Up to this point, the process is the same as that of the above-referenced copending application. Then, provision is made for predetermining a second set of protocols that the user at the receiving terminal must accept by appropriate data entry in order to access another digital file from the database via the Web, step 73. According to the protocols, step 73 must be in response to a predetermined number of portions in step 72 being accessed. Accordingly, these protocols could include an acceptance of the condition that sets a specified predetermined number of portions of the digital file that must be accessed before the user is given the option of accessing the entire digital file through the entry of the second set of protocols. Then, as shown in FIG. 3, provision may still be made for a step, as practiced in the referenced copending application, wherein there is included in said second set of protocols an appropriate data entry for to accessing the entire digital file from the database via the Web, step 74, also in response to a predetermined number of portions of step 72 being accessed.

Also, as in the copending application, provision may be made for the first set of data entry protocols to include provision for the setting of a small fee accepted by the user for each accessed file portion, and for the provision in the second set of protocols for a larger fee accepted by the user for the access of the entire digital file, step 75. In this connection, the present application provides for permitting access of the another digital file of step 73 as a reward without any fee in response to a predetermined number of portions of step 72 being accessed.

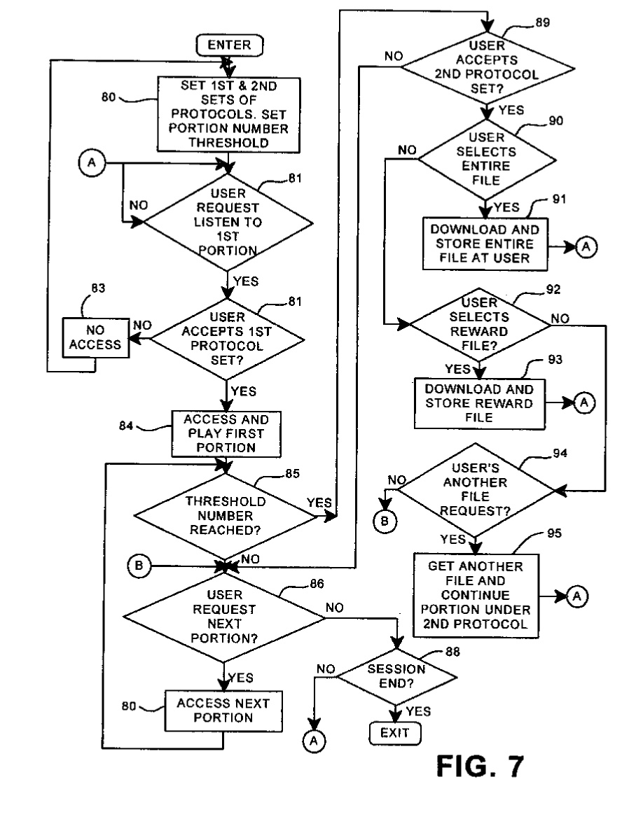

With reference to the flowchart of FIG. 7, a simplified illustrative run of the process set up in FIG. 6 will be described. The first and second sets of predetermined protocols, as well as the threshold number of portions which must be accessed before the whole digital file may be accessed are set up in the system, step 80. Next, a determination is made as to whether the user has requested an initial portion of the entire digital file, step 81. If Yes, then a further determination is made as to whether the user has accepted the first set of protocols, step 82. If No, the user is denied access, step 83, and the process is returned to step 80. If the determination from step 82 is Yes, the user is enabled to access and play a first portion of the entire digital file, step 84. It should be noted that in this listening state the data for playing of the tune or song of the first portion is just in the form of a Web audio stream, i.e. it is moved in short duration data packets in and out of the cache 15, FIG. 1. The stream is transitory. It cannot be downloaded for storage. A determination is made as to whether the threshold number of portions that must be accessed before the entire digital file may be ordered has been reached, step 86. If Yes, a further determination is made as to whether the user accepts the second set of protocols, step 89. If Yes, then a further determination is made, step 90, as to whether the user has selected the option (covered in the copending application) of selecting to access the entire initial file. If Yes, then the entire digital file is downloaded and stored on the user's computer terminal, step 91, and the process is branched back to step 81 via branch “A”. On the other hand, if the determination in step 89 or step 85 is No, then a determination may be made, step 88, as to whether the user has ended the session. If Yes, the session is exited. If No, the process is branched via “A” back to step 81.

Now, if the decision in step 90 is No, a further determination is made as to whether, step 92, the user has chosen to receive a free award of a digital file offered after the user has purchased a predetermined number of portions of an initial digital music file, as described with respect to FIG. 5. If Yes, the reward file is downloaded and stored on the user's computer terminal, step 93, and the process is branched back to step 81 via branch “A”. If the decision is No, a further determination is made as to whether, step 94, the user has chosen to request another digital file after a predetermined number of portions of an initial digital music file has been accessed, as described with respect to FIG. 4. If Yes, the another file is downloaded and stored on the user's computer terminal, step 95, wherein the process of accessing and listening to potions of the accessed another digital file is continued; after which the process is branched back to step 81 via branch “A”. If the determination in step 94 is No, then the process is branched back to step 86 via branch “B”.

One of the preferred implementations of the present invention is in application program 40, i.e. a program made up of programming steps or instructions for accessing portions of the entire file, as well as the accessing of other digital files resident in RAM 14, FIG. 2, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A computer controlled method for accessing digital files from a database comprising:
determining a first set of data entry protocols for enabling a user to access a portion of an initial digital file;
enabling the user to access said portion by entering said first set of protocols;
determining a second set of data entry protocols for enabling a user to access another digital files from a database, including a protocol requiring said user to access a predetermined number of portions of said initial digital file; and
enabling a user to access said another digital file, in response to said user accessing said predetermined number of portions by entering said second set of data entry protocols.

2. The method of claim 1 wherein said another digital file is accessed from said database via a communications network.

3. The method of claim 2 wherein said communications network is the World Wide Web.

4. The method of claim 3 wherein said initial and another digital files are audio files comprising musical presentation content, and said portions are units of the musical presentation.

5. The method of claim 4 further including the step of offering said user a selection of a plurality of digital files of musical presentations from which the user may select said another digital file.

6. The method of claim 5 wherein said first set of data entry protocols includes a dialog offering to the user an acceptance by said user of payment of a first fee for each accessed portion, and the user selection of said acceptance from said dialog.

7. The method of claim 6 further including:
providing a third set of data entry protocols for enabling a user to pay a second fee for the entire initial digital file in lieu of a total fee of said first fees for all accessed portions wherein said second fee is greater than said total fee; and
enabling said user to selectively substitute said accessed another digital file for said initial digital file.

8. A computer controlled system for accessing digital files from a database comprising:
means for determining a first set of data entry protocols for enabling a user to access a portion of an initial digital file;
means for enabling a user to access said portion by entering said first set of protocols;
means for determining a second set of data entry protocols for enabling the user to access another digital file from a database, including a protocol requiring said user to access a predetermined number of portions of said initial digital file; and
means, responsive to said user accessing said predetermined number of portions, for enabling a user to access said another digital file by entering said second set of data entry protocols.

9. The computer controlled system of claim 8 wherein said digital file is accessed from said database via a communications network.

10. The computer controlled system of claim 9 wherein said network is the World Wide Web.

11. The computer controlled system of claim 10 wherein said initial and another digital file are audio files comprising musical presentation content, and said portions are units of the musical presentation.

12. The computer controlled system of claim 11 further including means for offering said user a selection of a plurality of digital files of musical presentations from which the user may select said another digital file.

13. The computer controlled system of claim 12 wherein said first set of data entry protocols includes:
dialog means offering to the user an acceptance by said user of payment of a first fee for each accessed portion, and
means for the user selection of said acceptance from said dialog.

14. The computer controlled system of claim 13 further including:
means for providing a third set of data entry protocols for enabling a user to pay a second fee for the entire initial digital file in lieu of a total fee of said first fees for all accessed portions wherein said second fee is greater than said total fee; and
means for enabling said user to selectively substitute said accessed another digital file for said initial digital file.

15. A computer program, operable in a computer controlled system, having code recorded on a computer readable medium for accessing digital files from a database comprising:
means for determining a first set of data entry protocols for enabling a user to access a portion of an initial digital file;
means for enabling a user to access said portion by entering said first set of protocols;
means for determining a second set of data entry protocols for enabling the user to access another digital file from a database, including a protocol requiring said user to access a predetermined number of portions of said initial digital file; and
means, responsive to said user accessing said predetermined number of portions, for enabling a user to access said another digital file by entering said second set of data entry protocols.

16. The computer program of claim 15 wherein said digital file is accessed from said database via a communications network.

17. The computer program of claim 16 wherein said network is the World Wide Web.

18. The computer program of claim 17 wherein said initial and another digital file are audio files comprising musical presentation content, and said portions are units of the musical presentation.

19. The computer program of claim 18 further including means for offering said user a selection of a plurality of digital files of musical presentations from which the user may select said another digital file.

20. The computer program of claim 19 wherein said first set of data entry protocols includes:
dialog means offering to the user an acceptance by said user of payment of a first fee for each accessed portion, and
means for the user selection of said acceptance from said dialog.

21. The computer program of claim 20 further including:
means for providing a third set of data entry protocols for enabling a user to pay a second fee for the entire initial digital file in lieu of a total fee of said first fees for all accessed portions wherein said second fee is greater than said total fee; and
means for enabling said user to selectively substitute said accessed another digital file for said initial digital file.
